(19) United States
(12) Patent Application Publication
(10) Pub. No.: US 2007/0179041 A1
(43) Pub. Date: Aug. 2, 2007

(54) Zirconia Ceramic

(75) Inventors: Michihito Muroi, Perth (AU); Geoff James Trotter, Perth (AU)

Correspondence Address: EDELL, SHAPIRO & FINNAN, LLC, 1901 RESEARCH BOULEVARD, SUITE 400, ROCKVILLE, MD, 20850, US

(73) Assignee: Advanced Nanotechnology Limited, Welshpool (AU)

(21) Appl. No.: 11/680,022

(22) Filed: Feb. 28, 2007

Related U.S. Application Data
(63) Continuation of application No. PCT/AU05/01324, filed on Sep. 1, 2005.

(30) Foreign Application Priority Data
Sep. 1, 2004 (AU) 2004904959

(51) Int. Cl. C04B 35/48

(52) U.S. Cl. 501/103; 501/105

(57) ABSTRACT

A multi-component powder is described for consolidation to form a sinterable green body for a zirconia ceramic. The multi-component powder comprises at least 80% by volume of nano-sized particles of zirconia and up to 20% by volume of a stabilising agent which may form a coating around the nano-sized particles of zirconia and is optionally in particulate form. A multi-component slurry formed by suspending the powder in a liquid is also described as well as a green body formed from either the slurry or the powder. A zirconia ceramic formed by sintering the green body is also described.

### CROSS-REFERENCE TO RELATED APPLICATIONS

This application is a continuation of International Patent Application No. PCT/AU2005/001324, filed Sep. 1, 2005 and entitled “A Zirconia Ceramic”, which claims priority from Australian Provisional Patent application number 2004904959, filed Sep. 1, 2004. The disclosures of the above-identified patent applications are incorporated herein by reference in their entireties.

### FIELD OF THE INVENTION

The present invention relates to a multi-component powder for consolidation to form a green body to be sintered into a zirconia ceramic. The term “multi-component powder” as used throughout this specification is used to describe a powder that is made up of two or more components, regardless of the way that they are distributed.

The present invention also relates to a multi-component slurry for the preparation of a green body to be sintered into a zirconia ceramic.

The present invention further relates to a green body for a sintered zirconia ceramic formed by consolidation of the multi-component powder as well as a method for producing the green body.

The present invention further relates to a zirconia ceramic formed by sintering of the green body as well as a method for producing the zirconia ceramic. The present invention relates particularly, though not exclusively, to a zirconia ceramic that has been sintered to near full theoretical density at a temperature considerably lower than the sintering temperature for conventional zirconia powders.

### BACKGROUND TO THE INVENTION

Zirconia ceramics are used in a wide range of applications owing to its unique mechanical and physical properties. Zirconia is typically used in is fully or partially stabilised form by doping with stabilising elements such as Y, Ce, Ca and Mg. Unlike most other engineering ceramics, which are hard and strong but brittle, partially stabilised zirconia ceramics possess high fracture toughness and wear resistance as well as high hardness and strength. These properties make partially stabilised zirconia ceramics suitable for use in demanding applications such as cutting tools, electronic components, engine components, grinding media and optical connector parts. Fully stabilised zirconia is used as an active material for oxygen sensors and an electrolyte for ceramic fuel cells, taking advantage of its high ionic conductivity.

It is accepted practice in the zirconia ceramic industry to calcine precursor powders to form zirconia doped with a stabilising element before consolidation of the powders to form so-called “green bodies”. A green body is formed by consolidation or compaction of powders. There are two main reasons for calcination of the powders. Firstly, almost all commercial zirconia powders currently available are produced using wet-chemical methods, such as (co-) precipitation and hydrolysis, the primary products of which are not crystalline zirconia, but rather amorphous compounds in the form of hydrates, nitrates, etc. of zirconium and a stabilising element. If calcination is not carried out prior to consolidation of the powders, large shrinkage and cracking occur upon heating of green bodies as these amorphous compounds decompose to form crystalline zirconia. During calcination the stabilising element dissolves directly into the zirconia. Secondly, calcination is considered essential to avoid abnormal grain growth.

Most zirconia ceramics are produced by sintering of a compacted green body. Because of the refractory nature of zirconia, conventional sintering of micron-sized zirconia powders has been conducted at a high temperature, typically well in excess of 15000C. More recently, sub-micron sized powders of zirconia have become available allowing the sintering temperature to be reduced, typically in the range 1400-1500° C. It is understood that this reduction in the sintering temperature is at least in part due to an increased driving force for surface area reduction when smaller particles are used. Low sintering temperatures are desirable to reduce the capital and operating costs of sinter plants but also to minimise grain growth during sintering.

To further reduce the sintering temperature, the use of nano-sized powders has extensively been investigated in the past few decades. Sintering to near full density has been reported for temperatures in the range of 950 to 1050° C. for nano-sized powders of stabilised or unstabilised zirconia with an average particle size less than 10 nm. To date, however, nano-sized zirconia powders with an average particle size less than about 50 nm have never been used for mass production of zirconia ceramics. The primary reason for this is the strong tendency for nano-sized zirconia particles to form hard agglomerates, ie agglomerates that do not break up during consolidation of the powders when forming a green body. When hard agglomerates form, it is extremely difficult to prepare homogeneous nano-crystalline green bodies (a prerequisite for low-temperature sintering).

Various methods have been devised in an attempt to overcome the agglomeration problem. One method is to use high pressures typically in the range of 500 MPa to 3 GPa to consolidate the nano-sized zirconia powders to break up hard agglomerates. This solution is impractical as it can only be used in the preparation of very small articles of simple shape. Another prior art method is the use of centrifugal consolidation which has been reported to result in the production of homogeneous nano-crystalline green bodies that can be sintered to near full density at a temperature of 1100° C. This technique is also problematic in that the production rates are very low and automation of centrifugal consolidation is extremely difficult.

The sintering of nano-sized zirconia powders to near full theoretical density at still lower temperatures has been achieved by carrying it out in a vacuum, under applied pressure, or both. It has been reported that a green body made of a 9-nm zirconia powder has been sintered to near full density at 975° C. in a vacuum; that a green body made of a 6-nm powder has been sintered to near full density at 950° C., or 900° C. in a vacuum, by means of sinter-forging under a pressure of 300 MPa; and that a green body made of the same powder has been sintered to near full density at 900° C. by hot pressing under a pressure of 400 MPa. With these prior art methods, the powder still has to be pressed at a relatively high pressure of the order of 400 MPa to obtain a sinterable green body, thus limiting their application to very small articles. Apart from this problem, these techniques, especially pressure-assisted sintering, are inherently much more complicated and more expensive than conventional pressureless sintering in air, and not suitable for mass production.

The present invention was developed to provide a multi-component powder for the production of zirconia ceramics using relatively low pressures for powder consolidation and low sintering temperature with a view to overcoming at least some of the problems associated with conventional techniques.

It will be clearly understood that, although prior art methods are referred to herein, this reference does not constitute an admission that any of these form a part of the common general knowledge in the art in Australia or in any other country.

In the statement of invention, the description and the claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### SUMMARY OF THE INVENTION

According to a first aspect of the present invention, there is provided a multi-component powder for consolidation to form a sinterable green body for a zirconia ceramic, the multi-component powder comprising:
at least 80% by volume of nano-sized particles of zirconia; and,
up to 20% by volume of a stabilising agent.

According to a second aspect of the present invention there is provided a multi-component slurry for the preparation of a sinterable green body for a zirconia ceramic, the multi-component slurry comprising:
at least 80% by volume of nano-sized particles of zirconia; and,
up to 20% by volume of a stabilising agent, suspended in a liquid.

For each of the first aspect or the second aspect, the stabilising agent may form a coating around the zirconia particles and it is to be understood that the coating need not be continuous, but may equally be in particulate form. In another embodiment, the stabilising agent is in particulate form, and the particles of the stabilising agent may be intimately mixed with the zirconia particles without forming coatings. When the stabilising agent is in the particulate form, the average size of the particles of the stabilising agent is preferably not greater than 10 nm and more preferably in the range of 8 to 50 nm. The average particle size of the stabilising agent should not exceed the average particle size of the zirconia particles. The nano-sized particles of zirconia preferably have an average size in the range of 15 to 30 nm.

The nano-sized particles of zirconia used for the first or second aspect of the present invention may have a non-uniform size distribution which may be bimodal, multimodal or log-normal with the average size of the largest 10 vol % of the particles being at least three times that of the smallest 10 vol % of the particles.

The stabilising agent used for the first or second aspect may comprise one or more compounds selected from the group comprising rare earth metal oxides, calcium oxide, magnesium oxide and those precursor compounds which decompose to form the said oxides at temperatures below the sintering temperature of the zirconia ceramic. To facilitate doping of the zirconia, it is advantageous for the stabilising agent to comprise one or more compounds selected from the group comprising yttrium oxide, cerium oxide and those precursor compounds which decompose to form yttrium oxide or cerium oxide at temperatures below the sintering temperature of the zirconia ceramic.

The multi-component powder may further comprises up to 2% by volume of iron oxide or a precursor material that decomposes to form iron oxide at a temperature below the sintering temperature of the zirconia ceramic. Alternatively or additionally, the multi-component powder may further comprise up to 5% by volume of aluminium oxide or a precursor material that decomposes to form aluminium oxide at a temperature below the sintering temperature of the zirconia ceramic.

The multi-component powder may comprise 80-98%, preferably 85-94% by volume of nano-sized particles of zirconia. In one embodiment, the multi-component powder comprises not greater than 15% by volume of the stabilising agent. The zirconia may include zirconia doped with a stabilising element.

The multi-component slurry may comprise the multi-component powder of the first aspect of the present invention suspended in a liquid such as water.

According to a third aspect of the present invention there is provided a green body for sintering to produce a zirconia ceramic formed by consolidation of the multi-component powder according to the first aspect of the present invention.

The green body may be formed by dry compaction of the multi-component powder, for example, using uniaxial pressing, cold-isostatic pressing or the combination of both. Advantageously, the dry compaction of the green body may be carried out without a binder. Advantageously, the step of consolidation of the green body may be conducted at a pressure less than 200 MPa. Such a low pressure is able to be used because the nano-sized particles are not prone to agglomeration. In one embodiment, the green body is formed using plastic forming, preferably extrusion or injection moulding.

According to a fourth aspect of the present invention there is provided a green body for sintering to produce a zirconia ceramic formed from the multi-component slurry of the second aspect of the present invention. The green body may be formed from the multi-component slurry using slip casting, pressure filtration, centrifuge casting, tape casting and/or doctor blading.

To improve strength, the green body according to the third or fourth aspect of the present invention may be pre-fired at a temperature below the sintering temperature and preferably in the range of 500 to 800° C. prior to sintering to form a zirconia ceramic.

According to a fifth aspect of the present invention there is provided a zirconia ceramic produced by heating the green body of the third aspect of the present invention at a sintering temperature not greater than 1250° C., not greater than 1200° C., not greater than 1150° C. or in the range of 1100 to 1200° C.

Advantageously, the zirconia ceramic may be produced using pressureless sintering in air or in a vacuum. Alternatively, sintering may be conducted under pressure, for example using hot pressing, hot isostatic pressing or sinter-forging.

The zirconia ceramic may have a density after sintering of at least 90% theoretical density, at least 95% theoretical density or at least 98% theoretical density.

According to a sixth aspect of the present invention there is provided a zirconia ceramic comprising at least 80% tetragonal phase of zirconia and having a Vickers hardness greater than 9 GPa or a fracture toughness greater than 10 MPa.m^{1/2}.

According to a seventh aspect of the present invention there is provided a zirconia ceramic having a bending strength greater than 700 MPa, a Vickers hardness greater than 9 GPa and a fracture toughness greater than 7 MPa.m^{1/2}.

According to an eighth aspect of the present invention there is provided a multi-component powder substantially as herein described with reference to and as illustrated in the accompanying examples.

According to a ninth aspect of the present invention there is provided a multi-component slurry substantially as herein described with reference to and as illustrated in the accompanying examples.

According to a tenth aspect of the present invention there is provided a green body substantially as herein described with reference to and as illustrated in the accompanying examples.

According to an eleventh aspect of the present invention there is provided a zirconia ceramic substantially as herein described with reference to and as illustrated in the accompanying examples.

### BRIEF DESCRIPTION OF THE DRAWINGS

In order to facilitate a more comprehensive understanding of the nature of the invention, specific embodiments will now be described in detail, by way of example only, with reference to the accompanying drawings, in which:

FIGS. 1(a)-(e) are TEM photographs of 9Ce—ZrO₂ multi-component powders annealed at various temperatures;

FIG. 2 illustrates graphically the thermal expansion curves for a 9Ce—ZrO₂ multi-component powder compared with a prior art 2.5Y₂O₃—ZrO₂ single-phase powder, both consolidated using uniaxial pressing at 150 MPa with a heating/cooling rate of 300° C./h and holding for five hours at a sintering temperature of 1150° C.;

FIG. 3(a) and (b) illustrate the green density and sintered density, respectively, of two types of 9Ce—ZrO₂ powders plotted as a function of uniaxial pressure used for powder consolidation;

FIG. 4 illustrates schematically a theoretical model of the evolution of microstructure and Zr/Ce distributions with darker grey scale indicating higher Ce concentration;

FIG. 5 illustrates graphically the thermal expansion curves for powders having various compositions for multi-component powders consolidated by uniaxial pressing at 150 MPa with sintering being conducted at a heating/cooling rate of 300° C./h and held for five hours at a temperature of 1150° C.;

FIG. 6 illustrates graphically the thermal expansion curves for multi-component powders having a cation molar ratio of Zr:Ce:Al:Fe=88.8:6:4:1.2, one prepared from ZrO₂ particles having an average size of 10 nm with a narrow size distribution and the other from ZrO₂ particles having an average size of 20 nm with a wide size distribution. For each case, the multi-component powders were consolidated using uniaxial pressing at 150 MPa. Sintering was conducted using a heating/cooling rate of 300° C./h and holding for five hours at 1150° C.;

FIG. 7 illustrates graphically the thermal expansion curves for multi-component powders having a cation molar ratio of Zr:Ce:Al:Fe=88.8:6:4:1.2, one prepared from ZrO₂ powder having a primary particle size of 30 nm with a narrow size distribution and the other from ZrO₂ powder having an average particle size of 20 nm with a wide size distribution. For each case, the multi-component powders were consolidated using uniaxial pressing at 150 MPa. Sintering was conducted using a heating/cooling rate of 300° C./h and holding for five hours at 1150° C.;

FIG. 8 illustrates graphically the thermal expansion curves for powders having a cation molar ratio of Zr:Ce=91:9. The multi-component powders were prepared either by mixing 20 nm ZrO₂ slurry and 7 nm CeO₂ slurry or by adding Ce by precipitation. For each case, the multi-component powders were consolidated using uniaxial pressing at 150 MPa. Sintering was conducted using a heating/cooling rate of 300° C./h and holding for five hours at 1150° C.;

FIG. 9 shows an SEM photograph of the fracture surface of a ceramic with a density of 6.23 g/cm3 obtained by sintering the green body of FIG. 2 at a temperature of 1180° C. for 8 hours; and,

FIG. 10 illustrates graphically Fracture toughness (K_{IC}) versus Vickers hardness (H_{V}) for a number of zirconia ceramics prepared through consolidation of multi-component powders by uniaxial pressing at 150 MPa, followed by sintering at temperatures ranging between 1100 and 1200° C. For comparison purposes a data point for a ceramic prepared from a commercial 2.5Y203-ZrO2 powder (sintered at a higher temperature of 1600° C. to achieve full density) is shown in FIG. 10 and marked with a cross (+).

### DETAILED DESCRIPTION OF EMBODIMENTS OF THE PRESENT INVENTION

Before the preferred embodiments of the present methods are described, it is understood that this invention is not limited to the particular types of stabilising agents, sintering temperatures and compositional ratios described. It is also to be understood that the terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

Throughout this specification reference is made to “zirconia ceramics”. The term “zirconia ceramic” does not imply that the ceramic consists only of zirconia but rather that the ceramic consists predominately of zirconia. Thus reference to a zirconia ceramic includes reference to partially or fully stabilised zirconia to which a variety of stabilising elements may have been doped. It also includes reference to partly or fully stabilised zirconia to which a variety of substances that perform certain functions, such as a grain-growth inhibitor and/or a sintering aid, may have been added in minor quantities.

The term “zirconia” is used throughout this specification to refer to crystalline or amorphous zirconium oxide that may contain a variety of stabilising agents and additives, as described in the preceding paragraph, but is substantially free of water molecules or volatile anion groups such as OH⁻, NO₃⁻ and SO₄²⁻. It is further to be understood that the term “zirconia” is used regardless of the presence of impurities that may originate in raw materials or have been incorporated unintentionally during synthesis.

The term “nano-sized” would be readily understood by the person skilled in the art to which the present invention belongs as referring to powders that have an average size of 100 nm or less. The term “multi-component” is used to refer to the powder having more than one component, each component retaining substantially its own identity and none of the components forming a solid solution with each other to any substantial degree. It is to be understood that a multi-component powder or slurry may include various additives including one or more binders, dispersants, surfactants, deflocculants, plasticisers, viscosity modifiers and/or lubricants.

The term “stabilising agent” is used to refer to an oxide, such as Y₂O₃, CeO₂, CaO and MgO, that forms a solid solution with zirconia to stabilise tetragonal or cubic structures. This term also refers to a precursor material that decomposes into one or more of these oxides at a temperature below the sintering temperature.

The term “rare earth metal” is used to refer to a group of metal elements comprising SC, Y and the lanthanide elements corresponding to atomic numbers between 57 and 71 inclusive.

The term “slurry” is used to refer to a system comprising solid particles suspended in a liquid, regardless of the solid content of the slurry or the type of the liquid. It is thus to be understood that the term “slurry” includes a highly viscous slurry, often termed a “slip”, used for a casting process.

The term “consolidation” as used with reference to the preparation of green bodies for sintering is to be understood to include any method of bringing together the particles contained in powders or slurries to make a body that is sufficiently firm so as to hold its shape.

The term “green body” is used to refer to any solid object made by bringing together the particles contained in powders or slurries, regardless of the shape of the object or the level of other volatile substances such as binders or other polymers that may have been incorporated, intentionally or unintentionally, during the preparation and consolidation of the powders or slurries.

Although other methods of forming green bodies or sintering green bodies to form zirconia ceramics than those described herein can be used to practice or test the various aspects of the present invention, specific methods are described below in detail with reference to the non-limiting.

Using the various embodiments of the present invention, zirconia ceramics have been produced with near full density at low sintering temperatures, typically between 1100 and 1200° C., even when the powders are consolidated at low pressures. The ceramics are formed from a consolidated multi-component powder or multi-component slurry comprising nano-sized particles of zirconia and a stabilising agent.

The multi-component powder comprises 80-98%, preferably 85-94%, by volume of zirconia particles that have an average size ranging between 8 and 50 nm and preferably between 15 and 30 nm. It is advantageous for the nano-sized zirconia particles to be substantially free from hard agglomerates. It was found that a volume fraction of zirconia lower than 80% or an average particle size smaller than 8 nm resulted in a lowering of the green density under a reasonable pressure. It was further found that with a volume fraction of zirconia higher than 98% or an average particle size greater than 50 nm or the use of zirconia powder containing hard agglomerates resulted in inhomogeneity in the distribution of the stabilising element which caused severe cracking upon cooling due to tetragonal-monoclinic phase transformations in those grains poor in the stabilising element.

The use of zirconia particles substantially free of water or volatile anion groups has been found to be beneficial in avoiding the unacceptable level of shrinkage that would occur if particles of undecomposed precursor materials were used.

In one embodiment, the multi-component powder contains no more than 20% and preferably no more than 15% by volume of a stabilizing agent. The stabilizing agent may be one or more of the rare earth oxides such as cerium oxide, yttrium oxide, or scandium oxide or a precursor material that decomposes to form one or more of the rare earth oxides at a temperature below the sintering temperature.

Alternatively or additionally, the stabilising agent may be calcium oxide, magnesium oxide or a combination of the two. The stabilising agent may equally comprise a precursor material that decomposes to form calcium or magnesium oxide at a temperature below the sintering temperature. It is to be clearly understood that decomposition of the precursor material occurs at an intermediate temperature between room temperature and the selected sintering temperature.

The stabilising agent may be intimately mixed with the nano-sized particles of zirconia in the form of particles with an average size less than 10 nm. Alternatively, the stabilising agent may form a coating over the nano-sized particles of zirconia. In the former case, it has been found that the use of particles of the stabilising agent greater than 10 nm in size results in an increase in the diffusion length of the stabilising elements, which is understood to make it difficult to achieve a reasonably homogeneous distribution of the stabilising agent at the low sintering temperatures used for the present invention.

It is noted that the restriction on the fraction of stabilising agent (<20 vol %) does not preclude the application of the present invention to zirconia ceramics having higher stabilising agent contents. In such a case, a multi-component powder containing low-doped crystalline zirconia particles, instead of pure zirconia particles, may be used to increase the overall stabilising agent content. For example, if the overall final composition of the zirconia ceramic is, say 70Zr:30Ce, it is possible to use a sufficient quantity of zirconia particles that have been pre-doped with cerium instead of pure crystalline zirconia. In this case, the volume fraction of additional stabilising agent added to the multi-component powder would still be not greater than 20vol %.

The multi-component powder may further comprise up to 2 vol % of iron oxide or up to 5 vol % of aluminium oxide or both to lower the sintering temperature and/or in suppressing grain growth. Alternatively or additionally, multi-component powder may comprise a precursor material which decomposes to form iron oxide or aluminium oxide upon heating. In either case, the iron or aluminium oxide or their precursor materials may be provided either in particulate form with an average size less than 10 nm or in the form of a coating over the nano-sized particles of zirconia.

In one embodiment of the present invention, the nano-sized particles of zirconia have a non-uniform size distribution or, more specifically, a bimodal, multimodal or log-normal size distribution, whereby the average size of the largest 10 vol % of the particles is at least three times that of the smallest 10 vol % of the particles. Conventional zirconia ceramic powders typically specify a uniform or narrow particle size distribution as being preferred. Moreover, the use of a multi-component powder having a non-uniform particle-size distribution has been dismissed in the prior art to which the present invention belongs. The reason for this is that, using conventional methods of production of zirconia ceramics, a non-uniform size distribution frequently leads to abnormal grain growth in the early stage of sintering, thus making further densification difficult.

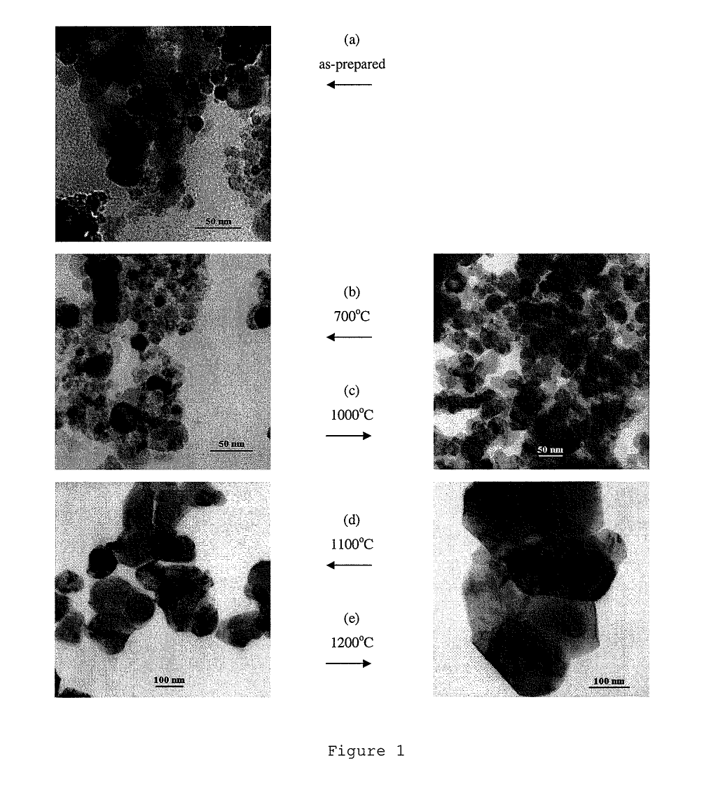

Without wishing to be bound by theory, this problem of abnormal grain growth is mitigated using the various embodiments of the present invention in that a non-uniform particle-size distribution is combined with a non-uniform elemental distribution. This is best illustrated in FIG. 1, where TEM photographs are shown of a multi-component powder in accordance with this preferred form of the invention after heating to various annealing temperatures (Ta). The multi-component powder of FIG. 1 has an overall cation composition of 91% Zr and 9% Ce. The multi-component powder was prepared by increasing the pH of a solution of CeOCl₃.8H₂O in which nano-sized particles of zirconia were suspended, as described in greater detail in Example 1 below.

With reference to FIG. 1(a), the as-prepared multi-component powder comprises nano-sized particles of zirconia having a non-uniform wide size distribution with particle sizes mostly in the range between 5-50 nm. The multi-component powder further comprises a cerium-containing material (amorphous cerium hydroxide). Elemental mapping of the region shown in FIG. 1(a) and performed using EELS (Electron Energy Loss Spectroscopy) revealed that the cerium-containing material tended to coat the zirconia particles. It was not possible to ascertain with certainty whether this coating was continuous or in particulate form due to insufficient spatial resolution using EELS.

Upon heating, the particle-size distribution changes only slightly with temperature up to 700° C. [FIG. 1(b)]. As the Ta increases from 700 to 1000° C., smaller particles grow into larger ones, whereas the size of larger particles (˜50 nm) scarcely changes, resulting in a narrowing of the particle-size distribution. Grain growth occurs predominantly among the smaller particles, presumably due to the rate of surface diffusion being high enough for these smaller particles to allow grain growth and grain-boundary migration.

As can be seen in FIG. 1(c), at Ta=1000° C., the particles are still fairly well separated from one another with no indication of significant sintering between them. This is consistent with the particle size observed in FIG. 1(c) being comparable to the value derived from a measurement of the BET surface area, 59 nm as well as the measured thermal expansion curve for a pressed pellet shown in FIG. 2 which is almost flat up to a temperature of 1000° C.

When the multi-component powder was heated to 1100° C. [FIG. 1(d)], adjacent particles were well sintered, while the grain size remained fairly uniform, although the average size has increased. It was observed that sintering proceeded very rapidly above 1000° C., which is consistent with the measured thermal expansion curve shown in FIG. 2. As illustrated in FIG. 2, the ceramic achieved almost full density (6.12 g/cm³) after sintering at 1150° C. for 5 hours.

FIG. 9 shows an SEM photograph of the fracture surface of a ceramic with a density of 6.23 g/cm³, obtained by sintering the same green body as for FIG. 2 at a temperature of 1180° C. for 8 hours. FIG. 9 demonstrates that the ceramic is fully dense and consists of grains of the order of 300 nm. It should be noted that the grain size is quite uniform in spite of the non-uniform particle size distribution of the original powder.

Without wishing to be bound by theory, the ability of the multi-component powder to sinter at a low temperature is ascribed to the following two factors. Firstly, just before significant densification starts, the multi-component powder consists of closely packed particles of roughly uniform size [refer to FIG. 1(c)] which is an ideal condition for densification. Secondly, the composition is not uniform among those particles which are about to sinter: particles originating from finer zirconia particles have a higher Ce content than those originating from coarser zirconia particles, since a local region containing finer zirconia particles is richer in Ce than that containing coarser zirconia particles in the original multi-component powder.

The formation of a homogenous solid solution will then result in a reduction in the free energy associated with the entropy of mixing, providing an additional driving force for bulk diffusion, necessary for densification.

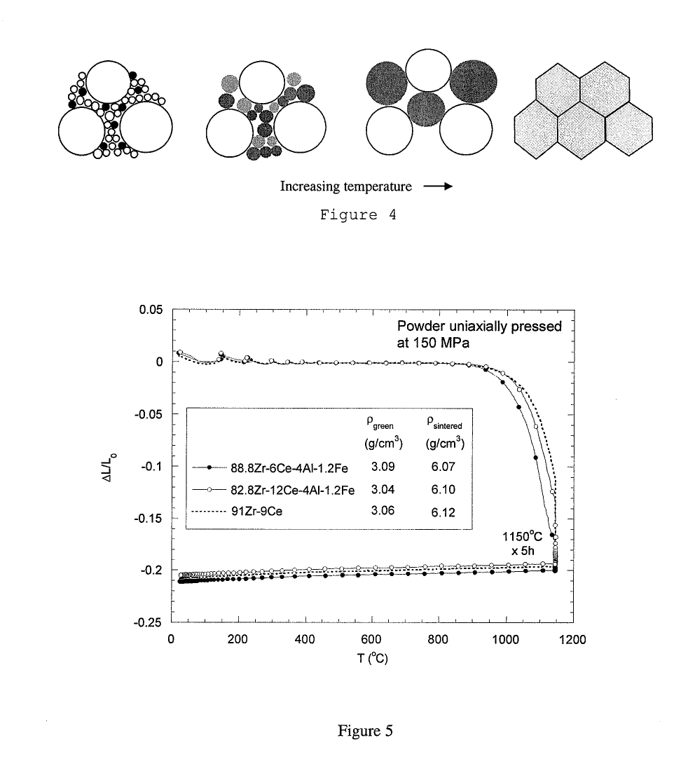

Schematic diagrams showing the evolution of microstructure and Zr/Ce distributions during the sintering process described above are shown in FIG. 4. In the diagrams, local Ce concentrations are indicated by the darkness with darker grey scale corresponding to higher Ce concentration.

In addition to its high sinterability, the multi-component powder of the present invention has another advantage. When the multi-component powder is consolidated to form a green body, the green body, in most cases, is strong enough to withstand subsequent handling and processing and can be prepared using uniaxial pressing or cold isostatic pressing of the multi-component powder in (semi)dry form without the need to add a binder. Conventional methods of producing zirconia ceramics typically include the step of adding a binder of a polymeric material such as polyvinyl alcohol to provide green strength prior to sintering. The green strength for binder-free multi-component powders made in accordance with the various embodiments of the present invention was found to be comparable to or higher than that for conventional zirconia powders to which a binder had been added. When binders are used in the prior art, the sintering process includes the step of heating the green body to an intermediate binder burn-off temperature. This step, which is both costly and time-consuming, is no longer required for green bodies that are free of binder.

Thus one of the advantages of the present invention is that use of a binder is optional. It is to be understood however, that a binder may be added if desired to assist in the consolidation of the multi-component powder. Even when a green body is formed by dry compaction, a binder may be added to improve green strength, which might be necessary, for example, in the production of ceramic articles of larger size. When the powder is consolidated by plastic forming, such as extrusion and injection moulding, adding a binder, as well as other additives such as a plasticiser and a lubricant, is almost certainly necessary.

A higher green strength may be required for large green bodies which require extensive machining. A higher green strength can be attained by heating the powder compact at an intermediate firing temperature below the final sintering temperature, typically in the range 500-800° C. At least a portion of the machining can be conducted after heating the green body to the intermediate firing temperature. The strength of the green body after firing at the intermediate firing temperature is much higher than the original strength of the green body but lower than the strength of the sintered ceramic.

The green body may be formed from the multi-component powder using various methods. In one embodiment, the green body is formed by dry compaction of the multi-component powder. Dry compaction includes, but not limited to, uniaxial pressing, cold-isostatic pressing and the combination of the two. Dry compaction to a high green density under a moderate pressure is extremely difficult with conventional zirconia nano-sized powders. Whilst dry compactions is particularly advantageous, other methods of consolidating the multi-component powder to form a green body may equally be employed including but not limited to slip casting, injection moulding, extrusion, pressure filtration, tape casting and /or centrifuge casting.

In one embodiment of the present invention, it is possible to form a green body directly from a multi-component slurry comprising nanoparticles of zirconia and a stabilising agent suspended in a liquid. The slurry may equally be prepared by providing a suspension of nanoparticles in a liquid and adding the stabilising agent to the suspension. This is advantageous in that the nano-sized particles need not be subjected to a drying stage and thus the problems associated with agglomeration of dry nanoparticles are able to be avoided. This allows for the green body to be formed using wet techniques including but not limited to slip casting, pressure filtration and centrifugal casting.

The green body formed using a multi-component powder or multi-component slurry may be sintered to near full density at a temperature below 1250° C., typically between 1100 and 1200° C. Sintering at higher temperatures is possible but not desirable, as it results in unnecessary grain growth.

To further illustrate aspects of embodiments of the present invention, the following non-limiting examples are provided.

### EXAMPLE 1

A multi-component powder with an overall cation molar ratio of Zr:Ce=91:9 was prepared using a combination of mechanocamical processing of ZrOCl₂.8H₂O and a diluent phase of NaCl as described in US Pat. No. 6,203,768, the contents of which are incorporated herein by reference, and precipitation. The ZrOCl₂.8H₂O and NaCl were subjected to high energy ball milling then heat treated at a temperature of 750° C. after which the NaCl diluent phase was removed by washing with water. The product of this first stage is a slurry of 12 wt % nano-sized particles of zirconia suspended in water. The zirconia particles are kept in slurry form to avoid the formation of hard agglomerates that otherwise tend to form when nano-sized particles of zirconia are allowed to dry.

The average size of the nano-sized particles of zirconia in the slurry was about 20 nm with a relatively wide size distribution ranging approximately between 5 and 50 nm as illustrated in FIG. 1(a). The BET surface area of the nano-sized zirconia particles as measured for a dried sample of the powder was 54 m²/g.

As the next step in the process, the slurry was diluted with water to give a solid content of about 5 wt %. Depending on the desired final composition of the zirconia ceramic being produced, an appropriate amount of CeCl₃.7H₂O was added to the slurry. In this particular example, sufficient CeCl₃.7H₂O was added to provide an overall compositional ratio of Zr:Ce of 91:9. The pH of the solution was reduced to about 2 by the addition of an acid, in this example, HCl. Reducing the pH of the solution in this way is understood to improve the dispersability of the nano-sized particles in the solution.

Thereafter, the pH was increased to initiate precipitation of cerium hydroxide. In this example, the pH was increased by slowly adding 10 M NH₄OH to the solution under vigorous stirring until the pH increased to about 10. The precipitate, consisting of zirconia and cerium hydroxide, was washed with water to remove NH₄Cl. Washing with water was repeated until the salinity level decreased to below 50 ppm.

The washed precipitate was dried in a 60° C. oven overnight. The temperature at which the precipitate is dried is not critical to the working of the present invention as long as the dried powder remains a multi-component powder, that is, the zirconia and the stabilising agent do not form a solid solution to any substantial degree. It is however beneficial to dry the precipitate at a low temperature below about 200° C. and typically between 50° C. and 150° C.

In the multi-component powder thus prepared, zirconia particles and cerium-hydroxide particles are intimately mixed, with the latter tending to surround or coat the former, a tendency confirmed by elemental mapping using EELS. Consolidation of the powder by uniaxial pressing at a moderate pressure of 150 MPa resulted in a green body having a density of 3.06 g/cm³, corresponding to about 50% of the theoretical density of Ce-doped ZrO₂. This green density was higher than that for a commercial Y-doped zirconia (YSZ) powder (2.96 g/cm³) pressed under the same condition, in spite of the fact that the YSZ powder had a greater average particle size (˜30 nm).

As can be seen in FIG. 2, after sintering at 1150° C. for 5 hours, the green body made of the 9Ce—ZrO₂ multi-component powder achieved almost full density (6.12 g/cm³), while the green body made of the commercial YSZ resulted in a much lower density (3.85 g/cm³), corresponding to only about 64% of the theoretical density. The sintered 9Ce—ZrO₂ ceramic consisted essentially of 100% tetragonal phase.

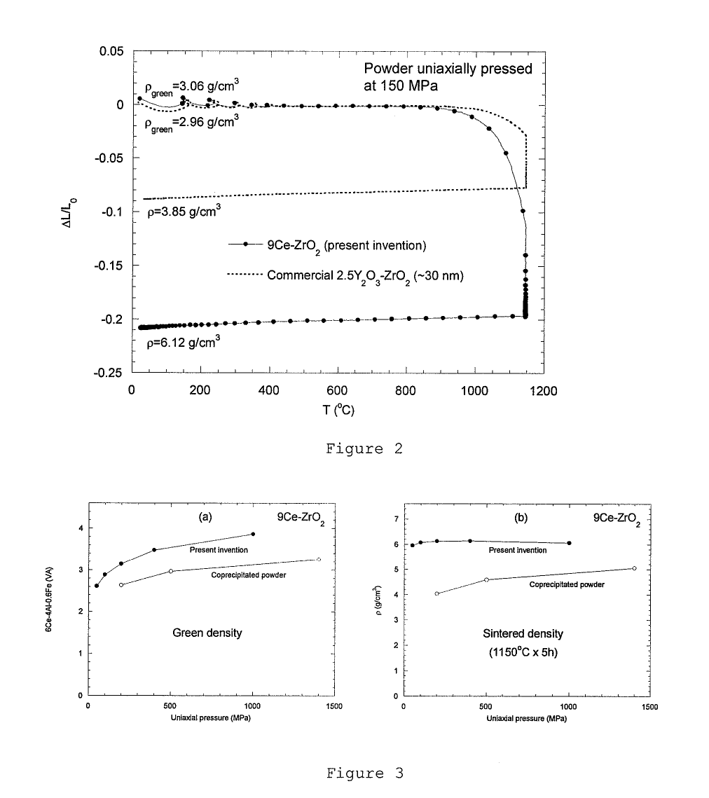

FIG. 3(a) and (b) show the green densities and densities after sintering at 1150° C. for 5 hours, respectively as a function of uniaxial pressure used for compaction for two powders: the 9Ce—ZrO₂ multi-component powder according to this invention (Powder I) and another 9Ce—ZrO₂ powder having an average particle size of 10 nm with a narrow size distribution, prepared by a standard coprecipitation technique, starting from a solution of ZrOCl₂.8H₂O and CeCl₃.7H₂O (Powder II).

For a given pressure the green density for Powder I is considerably higher than for Powder II. A green density of around 45%, generally considered necessary to achieve full density after sintering, was attained for Powder I using a uniaxial pressure of 50 MPa. The difference in the sintered densities is also remarkable. For Powder I, the density is almost independent of pressure above ˜100 MPa, and a nearly fully dense (˜97.5%) ceramic is obtained even at a low pressure of 50 MPa. For Powder II, by contrast, the density increases considerably with increasing pressure and is only about 82% of the theoretical density even at a very high pressure of 1.4 GPa.

### EXAMPLE 2

Multi-component powders with overall cation molar ratios of Zr: Ce:Al:Fe of 88.8:6:4:1.2 and 82.8:12:4:1.2 were prepared in the same way as in Example 1 except that appropriate amounts of Al₂Cl₄(OH)₂ and FeCl₃, as well as CeCl₃.7H₂O, were added to the slurry prior to the precipitation step.

Thermal expansion curves for green bodies prepared by uniaxial pressing of the multi-component powders at 150 MPa are shown in FIG. 5. Comparison with the curve for the 9Ce—ZrO₂ multi-component powder described in Example 1 (shown with dotted line) clearly indicates that the multi-component powders containing Al and Fe sinter at lower temperatures. The data also indicate that the sintering temperature increases with Ce content. Separate sintering experiments showed that the multi-component powder containing 6% Ce, 4% Al and 1.2% Fe became essentially fully dense after sintering at 1120° C. for 3 h, while at least 1150° C. was necessary for the other two powders to become fully dense. The crystal structure of the sintered ceramic was essentially 100% tetragonal regardless of Ce content or sintering temperature.

### EXAMPLE 3

A multi-component powder with an overall cation molar ratio of Zr:Ce=70:30 was prepared in the same way as in Example 1 except that a zirconia powder containing 20% CeO₂, instead of pure zirconia powder, was used and the amount of CeCl₃.7H₂O added to the slurry prior to the precipitation step was adjusted accordingly.

A green body obtained by uniaxial pressing at 150 MPa had a density of 3.21 g/cm³. The green body became almost fully dense (6.27 g/cm³) after sintering at 1200° C. for 5 hours. The crystal structure of the sintered zirconia ceramic was 100% cubic.

By contrast, a multi-component powder with the same cation molar ratio of Zr:Ce=70:30 prepared from pure zirconia particles, as in example 1, could not be sintered to full density even at 1250° C., because it contained too much cerium hydroxide.

### EXAMPLE 4

A multi-component powder with an overall cation molar ratio of Zr:Y=96:4 was prepared in the same way as in Example 1 except that an appropriate amount of YCl₃, instead of CeCl₃.7H₂O, was added to the slurry prior to the precipitation step.

A pellet obtained by uniaxial pressing at 150 MPa had a density of 3.09 g/cm³. It became almost fully dense (6.02 g/cm³) after sintering at 1180° C. for 8 hours. The sintered ceramic consisted of 97% tetragonal and 3% monoclinic phases.

### EXAMPLE 5

A multi-component powder with an overall cation molar ratio of Zr:Ce:Y=94:4:2 was prepared in the same way as in Example 1 except that an appropriate amount of YCl₃, together with CeCl₃.7H₂O, was added to the slurry prior to the precipitation step.

A green body obtained by uniaxial pressing of the multi-component powder at 150 MPa had a density of 3.13 g/cm³. The green body became almost fully dense (6.11 g/cm³) after sintering at 1180° C. for 5 hours. The crystal structure of the sintered ceramic was essentially 100% tetragonal.

### EXAMPLE 6

A multi-component powder with an overall cation molar ratio of Zr:Ce:Al:Fe=88.8:6:4:1.2 was prepared in the same way as in Example 2 except that use was made of zirconia particles having an average size of 10 nm and a narrow size distribution as a comparison with a multi-component powder for which the zirconia particles had an average size of 20 nm and a wide size distribution.

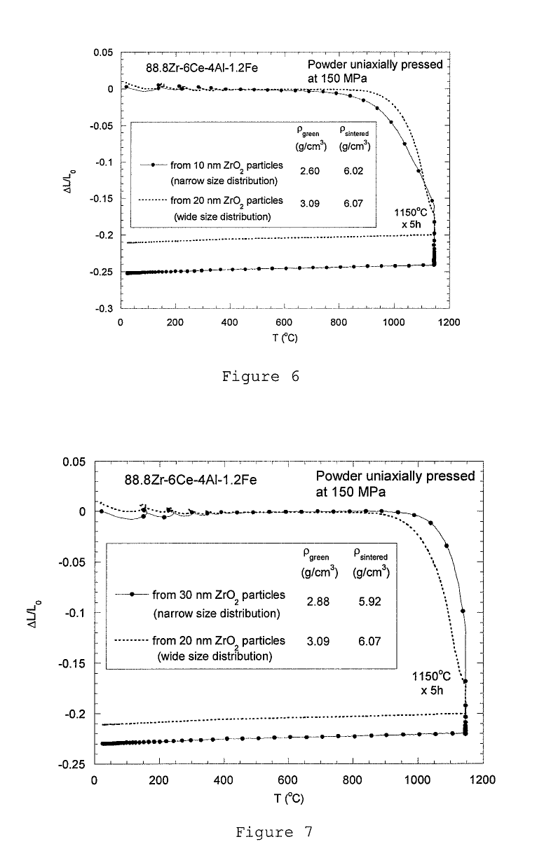

FIG. 6 shows a thermal expansion curve for the multi-component powder thus prepared (Powder I), together with one for a multi-component powder prepared from the 20 nm zirconia particles having a wide size distribution (Powder II). The measurements shown in FIG. 6 were taken from green bodies that had been formed by uniaxially pressing each multi-component powder at 150 MPa. Although both green bodies became almost fully dense, essentially 100% tetragonal ceramics after sintering at 1150° C. for 5 hours, the green density was considerably lower for Powder I (2.60 g/cm³) than for Powder II (3.09 g/cm³). Consequently the ceramic made of Powder I exhibited much greater shrinkage.

It is noted that the temperature at which shrinkage starts is considerably lower for Powder I than for Powder II, reflecting the smaller average particle size of the former. It was further observed that sintering at increasing temperature proceeds much more slowly for Powder I than for Powder II. As a result, the temperature required for full densification was similar for both multi-component powders. Without wishing to be bound by theory, possible reasons for this are the following. Firstly, attractive interactions between particles would be stronger for Powder I because of the smaller average particle size. Thus, the pressure used for powder compaction (150 MPa) may have been insufficient to break up any hard agglomerates present in Powder I. Secondly, the driving force for atomic diffusion associated with the entropy of mixing is practically absent in the sintering of Powder I, since the size of the zirconia particles in it is uniform and little compositional variation is expected among grains prior to densification.

### EXAMPLE 7

A multi-component powder with an overall cation molar ratio of Zr:Ce:Al:Fe=88.8:6:4:1.2 was prepared in the same way as in Example 2 except that use was made of a commercial zirconia powder having a primary particle size of about 30 nm with a narrow size distribution (Z Tech, SF Ultra; wet-milled prior to use), instead of the multi-component powder comprising 20 nm sized zirconia particles having a wide particle-size distribution.

FIG. 7 shows a thermal expansion curve for the multi-component powder thus prepared (Powder I), together with one for a multi-component powder prepared from the 20 nm zirconia particles having a wide size distribution (Powder II). Measurements were made on green bodies made by uniaxially pressing each multi-component powder at 150 MPa. The green density was somewhat lower for Powder I (2.88 g/cm³) as compared with Powder II (3.09 g/cm³), suggesting that the effect of particle-size distribution on green density was greater than that of particle size itself. Although the onset of sintering occurs at a slightly higher temperature for Powder I, densification is nearly completed during the holding time of 5 hours at 1150° C. for both powders. The sintered density for a ceramic made using Powder I (5.92 g/cm³) is considered a near full density, given that the sintered pellet consisted of 73% tetragonal and 27% monoclinic phases. The sintered ceramic for Powder II, having the same composition, consisted essentially of 100% tetragonal phase. The large fraction of monoclinic phase for Powder I suggests the presence of agglomerates in the starting zirconia powder, which would increase the inhomogeneity scale in the distribution of dopant cations in the as-prepared powder and prevent the formation of a uniform solid solution at lower temperatures. A certain degree of agglomeration in the zirconia powder used for the preparation of powder I is not surprising, since it was supplied in the form of dry powder; in general, it is very difficult, if not impossible, to re-disperse the particles once dried.

### EXAMPLE 8

A multi-component powder with an overall cation molar ratio of Zr:Ce=91:9 was prepared by mixing a slurry containing ZrO₂ particles having an average size of 20 nm and a wide size distribution and a slurry containing CeO₂ particles having a nearly uniform size of 7 nm. The two slurries in appropriate proportions were wet-milled for 30 min using a SPEX mill with 3 mm Yttrium Stabilised Zirconia balls as grinding media. The pH of the mixed slurry was about 8. After milling, the pH of the slurry was increased to 12 by adding a 28% NH₄OH solution to make the particles flocculate and settle. The precipitate, collected by discarding the supernatant, was then dried at 60° C.

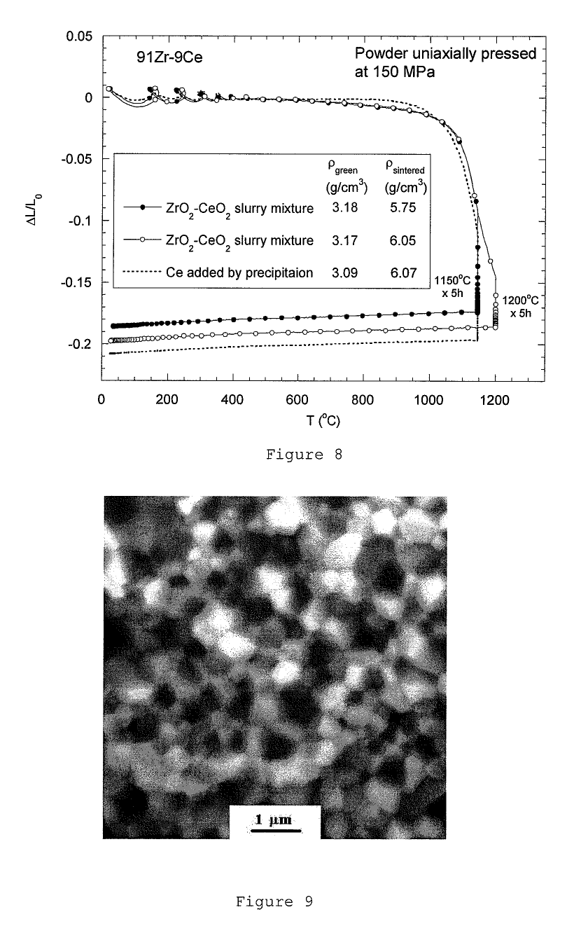

FIG. 8 shows thermal expansion curves for the multi-component powder thus prepared (Powder I), together with one for a multi-component powder prepared by adding Ce through precipitation as described in Example 1 (Powder II); the measurement was made on pellets uniaxially pressed at 150 MPa. It can be seen that, although the green density is somewhat higher for Powder I than for Powder II, the temperature required for full densification is slightly higher for Powder I (1200° C.) than for Power II (1150° C.). (The sintered pellets consisted essentially of 100% tetragonal phase in both cases.) It is also noted that small but noticeable shrinkage starts around 700° C. for Powder I, while the thermal expansion curve for Powder II is almost completely flat up to about 900° C.

Without wishing to be bound by theory, this difference in sintering behaviour may be explained as follows. In Powder I, particles of different types are expected to be distributed more or less randomly, since the zirconia and ceria slurries were mixed mechanically through ball milling. Sintering, or more likely grain growth, is favoured at lower temperatures in local regions that happen to be rich in ceria particles. Thermal expansion measurement on a green body made only of 7 nm ceria particles showed that noticeable shrinkage starts at a much lower temperature, around 400° C. In Powder II, by contrast, the Ce-containing material, probably cerium hydroxide, tends to coat zirconia particles, as explained above. In this case, the ceria that is formed upon decomposition of the hydroxide will readily diffuse into the zirconia particles to form a solid solution, rather than growing into larger particles.

Thus, a multi-component powder comprising zirconia particles coated with a stabilising agent produces better results than for a random mixture of zirconia and ceria particles.

### EXAMPLE 9

### Mechanical Testing

Zirconia ceramics prepared following procedures in accordance with the embodiments of the present invention were evaluated for Vickers hardness (H_{V}) and fracture toughness (K_{IC}) using a standard indentation technique. A load of 50 kg was applied to a polished surface of the ceramic for 15 seconds to make an indent.

In order to prepare the ceramics, including the larger ones used for the bending-strength testing, green bodies were made by uniaxial pressing of multi-component powders at 150 MPa, with no cold isostatic pressing (CIP) afterwards.

H_{V} was calculated on the basis of the equation:
(H_{V})=1.854 P/a²;
where, P is the load and a is the diagonal length of the indent.

K_{IC} was derived using the equation:
K_{IC}=9.052×10⁻³.H^{3/5}.E^{2/5} .a. c^{-1/2};
where, H is the hardness, E is Young's modulus assumed to be 200 GPa, a is the diagonal length of the indent, and c is the crack length. Three-point bending tests were also performed for selected samples, which were made into a bar-shape with typical dimensions of 1×2×25 mm³. Each measurement was made with a support span in the range 10-20 mm and a crosshead speed of 0.5 mm/min. The bending strength (σ) was calculated using the equation:
σ=3FL/(2 Wt²);
where, F is the force at break, L the support span, W the sample width, and t the sample thickness.

Results of mechanical testing are listed in Table 1 below, together with the nominal chemical composition, density and phase composition of the ceramics, as well as the sintering conditions used to produce the ceramic.

It can be seen from the results in Table 1, that the ceramics have excellent mechanical properties, with H_{V} of up to about 12 GPa, K_{IC} of up to about 27 MPa.m^{1/2} and σ of up to about 930 MPa. These values, particularly the high K_{IC} values for Ce-containing compositions, are among the best, if not the best, for zirconia ceramics currently available. It is also noted that those ceramics which are co-doped with Ce and Y have well-balanced mechanical properties: the hardness and bending strength are comparable to those of a ceramic made from a commercial Yttrium Stabilised Zirconia powder through high-temperature sintering, while the fracture toughness is much higher.

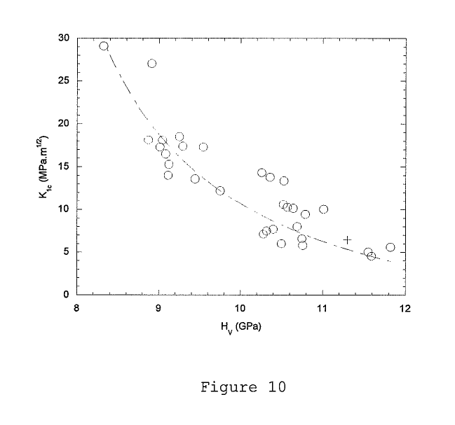

In FIG. 10, K_{IC} is plotted as a function of H_{V} for a number of zirconia ceramics including those listed in Table 1. It is readily apparent that K_{IC} and H_{V} are in a trade-off relationship and vary over wide ranges, demonstrating that the mechanical properties can be tailored to suit particular applications by adjusting the composition and sintering conditions within the scope of the present invention. For comparison, FIG. 10 includes a data point for a ceramic prepared from a commercial 2.5Y₂O₃—ZrO₂ powder (sintered at a higher temperature of 1600° C. to achieve full density indicated with a cross (+).

TABLE 1

| | | Sintered | | | Fracture | Bending |
|---|---|---|---|---|---|---|
| | Sintering | density | Tetragonal- | Hardness | toughness | strength |
| Composition | condition | (g/cm³) | phase fraction | (GPa) | (MPa · m^{1/2}) | (MPa) |
| 94Zr—6Ce | 1120° C. × 3 h | 6.03 | 0.99 | 9.1 | 16.5 | 675 |
| | 1150° C. × 5 h | 6.07 | 0.87 | 8.5 | 14.3 | — |
| 91Zr—9Ce | 1150° C. × 5 h | 6.12 | 1 | 9.1 | 14.0 | — |
| | 1180° C. × 8 h | 6.23 | 0.98 | 8.9 | 27.1 | 750 |
| | 1200° C. × 5 h | 6.24 | 1 | 9.0 | 17.3 | — |
| 85.8Zr—9Ce—4Al—1.2Fe | 1120° C. × 3 h | 5.94 | 1 | 9.8 | 6.7 | — |
| | 1150° C. × 5 h | 6.08 | 0.96 | 10.3 | 7.1 | 697 |
| | 1200° C. × 5 h | 6.19 | 0.97 | 10.3 | 7.4 | — |
| 82.8Zr—12Ce—4Al—1.2Fe | 1120° C. × 3 h | 5.96 | 1 | 9.0 | 6.0 | — |
| | 1150° C. × 5 h | 6.10 | 1 | 10.5 | 6.0 | |
| | 1200° C. × 5 h | 6.16 | 1 | 10.8 | 5.8 | 762 |
| 96.4Zr—3.6Y | 1150° C. × 5 h | 5.84 | 0.60 | 10.4 | 7.7 | — |
| 90.8Zr—4Y—4Al—1.2Fe | 1120° C. × 3 h | 5.97 | 0.92 | 11.8 | 5.6 | 931 |
| 94Zr—4Ce—2Y | 1150° C. × 5 h | 6.06 | 0.96 | 10.5 | 10.6 | — |
| | 1180° C. × 8 h | 6.11 | 0.97 | 10.4 | 13.8 | 907 |
| | 1200° C. × 12 h | 6.11 | 0.93 | 10.5 | 13.4 | — |
| 93Zr—5Ce—2Y | 1150° C. × 5 h | 5.85 | 1 | 9.1 | 5.4 | — |
| | 1180° C. × 8 h | 6.06 | 1 | 11.0 | 10.0 | 917 |
| | 1200° C. × 12 h | 6.11 | 0.98 | 10.6 | 10.3 | — |
| 94.4Zr—3Ce—2.6Y | 1150° C. × 5 h | 5.91 | 0.99 | 10.0 | 8.5 | — |
| | 1180° C. × 8 h | 6.02 | 0.98 | 10.8 | 9.4 | 926 |
| | 1200° C. × 12 h | 5.97 | 0.98 | 10.6 | 10.2 | — |
| 90Zr—2.5Ce—1.6Y—4Al—1Fe | 1100° C. × 5 h | 5.94 | 0.84 | 9.8 | 12.2 | — |
| | 1125° C. × 3 h | 5.97 | 0.96 | 10.3 | 14.3 | — |
| 94.5Zr—4Ce—0.5Ca—1Fe | 1150° C. × 3 h | 6.11 | 1 | 9.5 | 17.3 | — |
| 95Zr—5Y | 1600° C. × 20 h | 6.04 | 0.93 | 11.3 | 6.44 | 956 |
| (Commercial powder) | | | | | | |

Now that the preferred embodiments and illustrative examples of the present invention have been described in detail, the present invention has a number of advantages over the prior art, including the following:
a) the multi-component powders are easily compacted to reasonably high green density at relatively low pressure;
b) the sintering temperatures are much lower than for conventional zirconia ceramics reducing capital and operating costs;
c) high green strength is achieved without the need to add binders or interrupt heating to allow time for the binder to be burnt off prior to sintering;
d) a separate calcination step is avoided further reducing the cost of producing the zirconia ceramic and the need for dedicated calcining furnaces.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description and the appended claims.

What is claimed:

1. A multi-component powder for consolidation to form a sinterable green body for a zirconia ceramic, the multi-component powder comprising:
at least 80% by volume of nano-sized particles of zirconia; and
up to 20% by volume of a stabilising agent.

2. The multi-component powder of claim 1, wherein the stabilising agent forms a coating around the nano-sized particles of zirconia.

3. The multi-component powder of claim 2, wherein the stabilising agent forming a coating around the zirconia is in particulate form.

4. The multi-component powder of claim 1, wherein the stabilising agent is in particulate form, and the particles of the stabilising agent are intimately mixed with the nano-sized particles of zirconia.

5. The multi-component powder of claim 4, wherein the particles of the stabilising agent have an average particle size not greater than 10 nm.

6. The multi-component powder of claim 1, wherein the nano-sized particles of zirconia have an average size in the range of 8 to 50 nm.

7. The multi-component powder of claim 6, wherein the nano-sized particles of zirconia have an average size in the range of 15 to 30 nm.

8. The multi-component powder of claim 1, wherein the nano-sized particles of zirconia have a non-uniform size distribution.

9. The multi-component powder of claim 8, wherein the non-uniform size distribution is bimodal, multimodal or log-normal with the average size of the largest 10 vol % of the particles being at least three times that of the smallest 10 vol % of the particles.

10. The multi-component powder of claim 1, wherein the stabilising agent comprises at least one of rare earth metal oxides, calcium oxide, magnesium oxide and precursor compounds which decompose to form at least one of rare earth metal oxides, calcium oxides and magnesium oxides at temperatures below the sintering temperature of the zirconia ceramic.

11. The multi-component powder of claim 10, wherein the stabilising agent comprises at least one of yttrium oxide, cerium oxide and precursor compounds which decompose to form at least one of yttrium oxide and cerium oxide at temperatures below the sintering temperature of the zirconia ceramic.

12. The multi-component powder of claim 1, further comprising up to 2% by volume of iron oxide or a precursor material that decomposes to form iron oxide at a temperature below the sintering temperature of the zirconia ceramic.

13. The multi-component powder of claim 1, further comprising up to 5% by volume of aluminium oxide or a precursor material that decomposes to form aluminium oxide at a temperature below the sintering temperature of the zirconia ceramic.

14. The multi-component powder of claim 1, further comprising 80-98% by volume of nano-sized particles of zirconia.

15. The multi-component powder of claim 1, further comprising 85-94% by volume of nano-sized particles of zirconia.

16. The multi-component powder of claim 1, further comprising not greater than 15% by volume of the stabilising agent.

17. The multi-component powder of claim 1, wherein the zirconia includes zirconia doped with a stabilising element.

18. A multi-component slurry for the preparation of a sinterable green body for a zirconia ceramic, the multi-component slurry comprising:
at least 80% by volume of nano-sized particles of zirconia; and
up to 20% by volume of a stabilising agent, suspended in a liquid.

19. The multi-component slurry of claim 18, wherein the stabilising agent forms a coating around the nano-sized particles of zirconia.

20. The multi-component slurry of claim 19, wherein the stabilising agent that forms a coating around the zirconia is in particulate form.

21. The multi-component slurry of claim 18, wherein the stabilising agent is in particulate form, and the particles of the stabilising agent are intimately mixed with the nano-sized particles of zirconia.

22. The multi-component slurry of claim 21, wherein the particles of the stabilising agent have an average particle size not greater than 10 nm.

23. The multi-component slurry of claim 18, wherein the nano-sized particles of zirconia have an average size in the range of 8 to 50 nm.

24. The multi-component slurry of claim 23, wherein the nano-sized particles of zirconia have an average size in the range of 15 to 30 nm.

25. The multi-component slurry of claim 18, wherein the nano-sized particles of zirconia have a non-uniform size distribution.

26. The multi-component slurry of claim 25, wherein the non-uniform size distribution is bimodal, multimodal or log-normal with the average size of the largest 10 vol % of the particles being at least three times that of the smallest 10 vol % of the particles.

27. The multi-component slurry of claim 18, wherein the stabilising agent comprises at least one of rare earth metal oxides, calcium oxides, magnesium oxides and precursor compounds which decompose to form at least one of rare earth metal oxides, calcium oxides and magnesium oxides at temperatures below the sintering temperature of the zirconia ceramic.

28. The multi-component slurry of claim 27, wherein the stabilising agent comprises at least one of yttrium oxide, cerium oxide and precursor compounds which decompose to form at least one of yttrium oxide and cerium oxide at temperatures below the sintering temperature of the zirconia ceramic.

29. The multi-component slurry of claim 18, further comprising up to 2% by volume of iron oxide or a precursor material that decomposes to form iron oxide at a temperature below the sintering temperature of the zirconia ceramic.

30. The multi-component slurry of claim 18, further comprising up to 5% by volume of aluminium oxide or a precursor material that decomposes to form aluminium oxide at a temperature below the sintering temperature of the zirconia ceramic.

31. The multi-component slurry of claim 18, further comprising 80-98% by volume of nano-sized particles of zirconia.

32. The multi-component slurry of claim 18, further comprising 85-94% by volume of nano-sized particles of zirconia.

33. The multi-component slurry of claim 18, further comprising not greater than 15% by volume of the stabilising agent.

34. The multi-component slurry of claim 19, wherein the zirconia includes zirconia doped with a stabilising element.

35. The multi-component slurry of claim 18, wherein the liquid is water.

36. A green body for sintering to produce a zirconia ceramic formed by consolidation of the multi-component powder of claim 1.

37. The green body of claim 36 formed by dry compaction of the multi-component powder.

38. The green body of claim 37, wherein the dry compaction is uniaxial pressing, cold-isostatic pressing or the combination of both.

39. The green body of claim 37, wherein the dry compaction is carried out without a binder.

40. The green body of claim 37, wherein the step of consolidation is conducted at a pressure less than 200 MPa.

41. The green body of claim 36, wherein the green body is formed by plastic forming.

42. The green body of claim 41, wherein the plastic forming is extrusion or injection moulding.

43. The green body of claim 36, wherein the green body is pre-fired at a temperature below the sintering temperature prior to sintering to form a zirconia ceramic.

44. The green body of claim 43, wherein the green body is pre-fired at a temperature in the range of 500-800° C.

45. A green body for sintering to produce a zirconia ceramic formed by consolidation of the particles contained in the multi-component slurry of claim 18.

46. The green body of claim 45, wherein the green body is formed by slip casting, pressure filtration, centrifuge casting, tape casting and doctor blading.

47. The green body of claim 45, wherein the green body is pre-fired at a temperature below the sintering temperature prior to sintering of the green body to form a zirconia ceramic.

48. The green body of claim 47, wherein the green body is pre-fired at a temperature in the range of 500-800° C.

49. A zirconia ceramic produced by heating the green body of claim 36 to a sintering temperature not greater than 1250° C.

50. The zirconia ceramic of claim 49, wherein the sintering temperature not greater than 1200° C.

51. The zirconia ceramic of claim 50, wherein the sintering temperature is not greater than 1150° C.

52. A zirconia ceramic produced by heating the green body of claim 36 to a sintering temperature in the range of 1100 to 1200° C.

53. The zirconia ceramic of claim 49, wherein sintering is conducted under pressure.

54. The zirconia ceramic of claim 53, wherein sintering is conducted using hot pressing, hot isostatic pressing or sinter-forging.

55. The zirconia ceramic of claim 49, wherein the zirconia ceramic has a density after sintering of at least 90% theoretical density.

56. The zirconia ceramic of claim 55, wherein the zirconia ceramic has a density after sintering of at least 95% theoretical density.

57. The zirconia ceramic of claim 55, wherein the zirconia ceramic has a density after sintering of at least 98% theoretical density.

58. A zirconia ceramic comprising at least 80% tetragonal phase of zirconia and having a Vickers hardness greater than 9 GPa or a fracture toughness greater than 10 MPa.m^{1/2} .

59. A zirconia ceramic having a bending strength greater than 700 MPa, a Vickers hardness greater than 9 GPa and a fracture toughness greater than 7 MPa.m^{1/2}.
